(19) United States
(12) Patent Application Publication
(10) Pub. No.: US 2013/0144535 A1
(43) Pub. Date: Jun. 6, 2013

(54) METHOD FOR DETERMINING TIME CORRECTION FOR A DETECTOR PLACED ON THE SEABED

(71) Applicants: Jean-Luc Boelle, PAU Cedex (FR); Juan Cantillo, PAU Cedex (FR); Didier Lecerf, Massy (FR); Abderrahim Lafram, Massy (FR)

(72) Inventors: Jean-Luc Boelle, PAU Cedex (FR); Juan Cantillo, PAU Cedex (FR); Didier Lecerf, Massy (FR); Abderrahim Lafram, Massy (FR)

(73) Assignees: CGGVERITAS SERVICES S.A., Massy (FR); TOTAL SA, Courbevoie (FR)

(21) Appl. No.: 13/817,405

(22) PCT Filed: Aug. 16, 2011
(86) PCT No.: PCT/FR2011/051918

§ 371 Date: Feb. 15, 2013

(30) Foreign Application Priority Data
Aug. 16, 2010 (FR) 10 56617

(51) Int. Cl. G01V 1/38; G06F 17/00

(52) U.S. Cl. CPC G01V 1/38; G06F 17/00
USPC 702/18

(57) ABSTRACT

The invention relates to a method for determining, for a detector placed on the surface of the seabed, the vertical propagation time and the velocity of propagation in the water of a wave emitted from an emission point. The method includes: emitting a wave from the emission point; recording the wave received by the detector; determining the vertical propagation time by, where t_{dir} is the direct wave propagation time between the emission point and the detector, and tₘᵤₗ is the propagation time of the first multiple wave between the emission point and the detector; and determining the velocity of propagation of the wave, where X is the distance between the emission point and the water-surface point that is vertical to the detector.

### PRIORITY CLAIM

The present application is a National Phase entry of PCT Application No. PCT/FR2011/051918, filed Aug. 16, 2011, which claims priority from French Application Number 10 56617, filed Aug. 16, 2010, the disclosures of which are hereby incorporated by reference herein in their entirety.

### FIELD OF THE INVENTION

The invention relates to subsurface exploration techniques, and in particular to a method of determining, for a detector placed on the surface of the seabed, the vertical propagation time t₀ and the propagation velocity V in the water of at least one wave emitted from at least one emission point among N emission points.

### BACKGROUND

It is known, particularly in oil exploration, to produce seismic images from a series of geophysical measurements conducted from the surface of the subsoil. In the seismic technique, these measurements involve emitting a wave into the subsoil and measuring a signal containing reflections of the wave on the geological structures encountered. These structures are typically surfaces separating different geological strata or faults.

The seismic images are representations of the subsoil in two or three dimensions, with the vertical dimension of these dimensions corresponding either to the propagation times of the seismic waves, or to the depths. They are obtained by techniques known as “migration”, which use an estimated velocity model providing a map of the propagation velocity of the seismic wave in the rocks of the area being explored. This velocity model is used to estimate the positions of the reflectors in the subsoil based on seismic recordings. The seismic images produced in this way have some distortions of course, as do the underlying velocity models, because these are only estimates derived from a necessarily limited number of measurements.

In the case of marine subsurface exploration, detectors can be placed on the seabed above the subsoil to be explored. Seismic waves are emitted from points located close to the ocean surface. These waves propagate in the water and enter the subsoil. The detectors placed on the seabed on the surface of the subsoil will detect the arrival of the direct seismic wave as well as the waves reflected by the subsoil.

In order to monitor the evolution of a subsurface oil reservoir, it is possible to obtain a first seismic image of the subsoil at a given moment and then obtain a second seismic image of the same subsoil after a certain amount of time has passed.

In particular, to track changes in the hydrocarbon content of a reservoir in production, it can be useful to monitor the evolution of the seismic image of the subsoil over time.

In order to be able to compare two seismic images of the same subsoil captured at different times, it is important to know how to position each detector on the surface of said subsoil as accurately as possible. The patent application FR 10 52600 (corresponding to U.S. Patent Publication No. 2013/0041616 A1) describes a method for accurately determining the position of the detectors on the surface of the subsoil.

A feature of the detectors used is that they are autonomous. These detectors are equipped with an internal clock which must be synchronized before deployment and resynchronized after collection. As the data collection may extend over several months, time drifts may be observed.

The length of the acquisition period results in observing residual drifts in the internal clocks of the detectors, synchronization errors between detectors, particularly variations in the original time, and shifts related to possible variations in the propagation velocity of the seismic waves in the water. This is in addition to tidal effects, possible instabilities in the signal from the seismic source, imperfect positioning of the detectors and source points, imprecision in the propagation velocity of the waves in the water, and uncertainty in the bathymetry data.

Most of the methods used to compensate for these effects are sensitive to the phase of the source signal. In general, these methods cannot be completely executed in a single pass, and do not provide a measurement of the quality of the compensation other than the verification of proper phasing of seismic events.

A need therefore exists for a method which allows precisely determining the set of elements providing time corrections for detectors placed on the seabed.

### SUMMARY OF THE INVENTION

The invention therefore proposes a method for determining, for a detector placed on the surface of the seabed, a vertical propagation time (t₀) and a propagation velocity V in the water of at least one wave emitted from at least one emission point among N emission points, said method comprising, for at least one of the N emission points:
emitting at least one wave from said emission point,
recording the wave received by the detector,
determining the vertical propagation time t₀ by means of the following relation: Δ₀=tₘᵤₗ²−t_{dir}²=8t₀², where t_{dir} is the propagation time of the direct wave between the emission point and the detector and tₘᵤₗ is the propagation time of the first multiple wave between the emission point and the detector,
determining the propagation velocity V of the wave by means of the following relation:

$${Δ}_{1} = 9 {t}_{dir}^{2} - {t}_{mul}^{2} = {( \frac{2 \sqrt{2} X}{V} )}^{2} ,$$

where X is the distance between the emission point and the point on the water surface that is vertical to the detector.

In one embodiment of the invention, the quantities Δₗ and Δ₂ can be measured in the seismic images obtained while recording the wave received by the detector.

Advantageously, the method of the invention allows determining the vertical propagation time and the propagation velocity of the wave in the water located above the detector. The vertical propagation time and the propagation velocity allow determining the time corrections for a detector placed on the surface of the seabed.

A method of the invention may further comprise one or more of the following optional features, individually or in any possible combination:

the vertical propagation time t₀ is determined by:
resampling the recording of the wave received by the detector according to a change of variable T=t²,
autocorrelating the signal s(T) corresponding to the resampled recording of the wave received by the detector,
determining the quantity Δ₀ from the value of T corresponding to the main peak of the autocorrelated signal,

the propagation velocity is determined by:
resampling the recording of the wave received by the detector according to a change of variable T=9t²,
correlating the signal s(T) corresponding to the resampled recording according to the change of variable T=9t² with a signal s′(T) corresponding to the resampled recording according to the change of variable T=t²,
determining the quantity Δ₁ based on the value of T corresponding to the main peak of the correlated signal,

the quantity Δₗ is determined by means of the following relation: Δ₁=8t_{dir}²−Δ₀, t_{dir} being determined by means of the direct arrival time T_{dir} plotted on the recording of the wave received by the detector, said plotted direct arrival time T_{dir} corrected by the time shift dT₀=T₀−t₀ where T₀ is the estimated vertical propagation time and t₀ is the vertical propagation time determined by means of Δ₀,

based on the Δ₀ values determined for each of the N emission points, the Δ₀ values obtained for each of the emission points are modeled by means of the following equation: Δ₀^{mod}=D+B_{X}x+B_{y}y where x and y are the horizontal coordinates of each emission point in a reference system centered on the detector, and where D, B_{X} and B_{y} are modeling parameters for which the values are determined such that Δ₀^{mod} best fits the Δ₀ values obtained, for example in the least squares sense,

the vertical propagation time (t₀) being determined by means of the following relation:

$${t}_{0} = \frac{D}{\sqrt{8 D - {V}^{2} ( {B}_{x}^{2} + {B}_{y}^{2} )}} ,$$

based on the Δ₁ values determined for each of the N emission points, the Δ₁ values obtained for each of the emission points are modeled by means of the following equation: Δ₁^{mod}=A(x²+y²)+Fₓx+F_{y}y+E, where x and y are the horizontal coordinates for each emission point in a reference system centered on the detector, and where A, F_{X}, F_{Y} and E are modeling parameters for which the values are determined such that Δ₁^{mod} best fits the Δ₁ values obtained, for example in the least squares sense,

the propagation velocity (V) being determined by means of the following relation:

$$V = \frac{2 \sqrt{2}}{\sqrt{A}} ,$$

the angle γ between the normal to the plane tangential to the surface of the seabed at the location where the detector is placed and the vertical direction, and/or the angle η between the projection onto the horizontal plane (X, Y) of the normal to the plane tangential to the surface of the seabed at the location where the detector is placed and the X axis (X) in the reference system centered on the detector, is determined by:

$$η = {tan}^{- 1} ( \frac{{B}_{y}}{{B}_{x}} ) , γ = {tan}^{- 1} ( \frac{{Vt}_{0} \sqrt{{B}_{x}^{2} + {B}_{y}^{2}}}{D} ) ,$$

the angle γ between the normal to the plane tangential to the surface of the seabed at the location where the detector is placed and the vertical direction, and/or the angle η between the projection onto the horizontal plane (X, Y) of the normal to the plane tangential to the surface of the seabed at the location where the detector is placed and the X axis (X) in the reference system centered on the detector, is determined by:

$$η = {tan}^{- 1} ( \frac{{F}_{y}}{{F}_{x}} ) , γ = {sin}^{- 1} ( \frac{\sqrt{{F}_{x}^{2} + {F}_{y}^{2}}}{A V {t}_{0}} ) ,$$

and

after recording the wave received by the detector, up-field and down-field portions of the wave data are separated, and only the down-field portions of the data are used to determine the vertical propagation time t₀ and the propagation velocity V.

The invention also relates to a method for correcting a time origin of signals recorded by a detector placed on the surface of a seabed, said signals corresponding to waves emitted from at least one emission point among N emission points, wherein the signals received by the detector are corrected by means of a move-out method and by taking into account the time origin with the time t₀ and the propagation velocity V determined be means of a method according to the invention.

Advantageously, the method according to the invention is not sensitive to the so-called stretch effects which may be created by conventional methods. Lastly, it can be applied early in the processing sequence, while in more conventional methods the corrections specific to each detector are applied after migration, which requires always following the same processing and therefore does not allow implementing more elaborate techniques such as offset vector tiling.

The invention also relates to a computer program product comprising a series of instructions which, when loaded onto a computer, causes said computer to execute the steps of the method according to the invention.

### BRIEF DESCRIPTION OF THE DRAWINGS

The invention will be better understood by reading the following description, provided solely as an example and referring to the attached drawings in which:

FIG. 1 is a schematic representation of an arrangement of a detector and an emission point according to a first embodiment,

FIGS. 2a and 2b are schematic representations of an arrangement of a detector and an emission point according to a second embodiment,

FIG. 3a represents the time shift determined according to the invention for a set of detectors placed on the surface of a seabed,

FIGS. 3b and 3c represent the velocities, uncorrected and corrected for the time shift, obtained by a method according to the invention, and

FIG. 4 represents recordings of the waves emitted by a source and received by different detectors placed on the seabed, with and without correction of the time origins.

### DETAILED DESCRIPTION OF DRAWINGS

For clarity, the various elements represented in the figures are not necessarily to scale.

The method of the invention uses the arrival times of the direct wave and the multiple wave at the sea bed in order to estimate the vertical propagation time vertically to the detector as well as the propagation velocity in the water located between the detector and the emission point.

In the invention, “vertical propagation time” is understood to mean the time it would take for a direct wave emitted from an emission point located vertically to the detector to travel the distance between said emission point and said detector.

In the invention, “move-out method” is understood to mean methods for correcting the time shift due to the position in a horizontal plane of the emission point. Linear move-out or normal move-out are methods well-known to a person skilled in the art.

FIG. 1 represents a projection onto the vertical plane defined by the detector 10 placed on the seabed 11 and the emission point 12 located on the surface of the water.

As illustrated in FIG. 1, when a wave, particularly a seismic wave, is emitted from the emission point 12, said wave is propagated to the detector 10.

The wave can be propagated directly from the emission point 12 to the detector, and is then called a direct wave 14.

As is apparent in FIG. 1, the direct wave propagation time between the emission point and the detector satisfies the following equation:

$${t}_{dir}^{2} = {( \frac{Z}{V} )}^{2} + {( \frac{X}{V} )}^{2} ,$$

where Z is the depth at which the detector is placed on the seabed, X is the distance between the emission point and the point on the water surface vertical to the detector, and V is the mean propagation velocity of the wave in the water.

The wave emitted at the emission point 12 can also propagate from the emission point 12 to the detector 10 after being reflected on the seabed and the water surface, and the term “multiple wave” is then used.

The first multiple wave 16 corresponds to a reflection on the seabed and a reflection on the water surface before the wave reaches the detector.

As is apparent in FIG. 1, when the seabed 11 can be considered a horizontal plane, the propagation time of the first multiple wave between the emission point and the detector satisfies the following equation:

$${t}_{mul}^{2} = {( \frac{3 Z}{V} )}^{2} + {( \frac{X}{V} )}^{2} ,$$

where Z is the depth at which the detector is placed on the seabed, X is the distance between the emission point and the point on the water surface vertical to the detector, and V is the mean propagation velocity of the wave in the water.

From the equations satisfied by t_{dir} and tₘᵤₗ, it is possible to establish the following relations:

Δ₀=tₘᵤₗ²−t_{dir}²=8t₀² (equation 1) and

$$\begin{matrix}{Δ}_{1} = 9 {t}_{dir}^{2} - {t}_{mul}^{2} \\ = {( \frac{2 \sqrt{2} X}{V} )}^{2} .\end{matrix} \qquad ( equation 2 )$$

In one embodiment of the invention, equation (1) allows determining the vertical propagation time vertically to the detector 10. Advantageously, this approach does not require any prior knowledge of the propagation velocity of the wave in the water.

Equation (2) leads to the determination of the propagation velocity of the wave in the water.

In one embodiment of the invention, the method of the invention can comprise the following steps for estimating the quantity Δ₀: the seismic traces s(t) are resampled according to the variable T=t², then the quantity Δ₀ is obtained by plotting the main peak of the autocorrelation of the signal s(T).

Advantageously, the method of the invention is independent of the phase of the signal corresponding to the recording of the wave received by the detector.

In one embodiment of the invention, the quantity Δ₁ can be determined by following an analogous method with a resampling according to the variable T=9t² and a cross-correlation with the signal s(T=t²).

In one embodiment of the invention, the quantity Δ₁ can be obtained by means of the relation Δ₁=8(T_{dir}−T₀+t₀)²−Δ₀, where T_{dir} is the propagation time of the direct wave measured on the recording of the wave received by the detector, t₀ is the vertical propagation time determined by means of Ä₀, and T₀ is the estimated vertical propagation time.

From the definitions of Δ₀ and Δ₁, it is apparent that Δ₁=8t_{dir}²−Δ₀.

Analysis of Δ₀ leads to an error-free determination of the vertical propagation time t₀. Then a conventional plotting is made of the plotted direct arrival time T_{dir} on the recording of the wave received by the detector s(t). Preferably, this plotting is consistent with the traces recorded by the same detector and by different detectors (same plotting technique).

This plotted direct arrival time T_{dir} is known to within a certain precision, as a function of the detector. By following the procedure described in document FR 10 52600 (corresponding to U.S. Ser. No. 13/640,017), this time can be used to accurately determine the position of the detector, but also to provide an estimate of the time with zero shift T₀.

In general, this time is biased because the time origin of the data is inexact, and the plotting depends on the phase of the source signal.

By comparing T₀ and t₀ one obtains the time shift dT₀=T₀−t₀ for the detector, from which the quantity Δₗ can be determined in an unbiased manner by having t_{dir}=T_{dir}−dT₀.

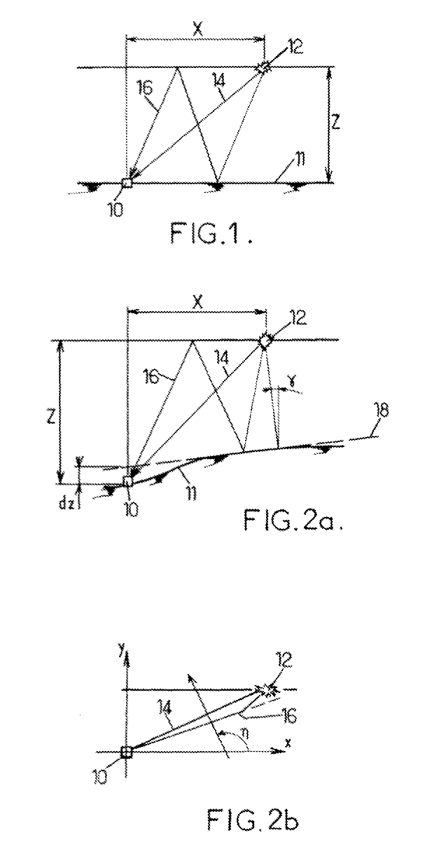

FIG. 2a represents a projection onto a vertical plane defined by the detector 10 placed on the surface 11 of the seabed and the emission point 12 on the ocean surface. As represented in FIG. 2a, the bathymetry can be more complex than for a flat seabed.

FIG. 2b represents a top view of the detector 10 and the emission point 12.

The inventors have observed that for a given detector, the variations in Δ₀ and Δ₁ with the horizontal distance between the detector and the emission point are respectively described by the following planar and quasi-parabolic models:

Δ₀^{mod}=D+Bₓx+B_{y}y (equation 3),

Δ₁^{mod}=A(x²+y²)+Fₓx+F_{y}y+E (equation 4).

In one embodiment, for a given detector, one therefore looks for the parametric surfaces defined by equations 3 and 4. From the parameters defining these surfaces, it is possible to obtain an estimate: of the vertical time t₀, of the reflection plane defined in particular by the angles γ, η, and the dimension dz, and the mean velocity V in the water concerned, by means of the following relations:

$$\begin{matrix}{t}_{0} = \frac{D}{\sqrt{8 D - {V}^{2} ( {B}_{x}^{2} + {B}_{y}^{2} )}} , \\ {η}_{0} = {tan}^{- 1} ( \frac{{B}_{y}}{{B}_{x}} ) , \\ {γ}_{0} = {tan}^{- 1} [ \frac{V {t}_{0} \sqrt{{B}_{x}^{2} + {B}_{y}^{2}}}{D} ] & ( equation 5 ) \\ V = \frac{2 \sqrt{2}}{\sqrt{A}} , \\ {η}_{1} = {tan}^{- 1} ( \frac{{F}_{y}}{{F}_{x}} ) , \\ {γ}_{1} = {sin}^{- 1} \frac{\sqrt{{F}_{x}^{2} + {F}_{y}^{2}}}{A V {t}_{0}} , \\ d z = \frac{2 E}{3 A V {t}_{0}} & ( equation 6 )\end{matrix}$$

The reflection plane is defined as being the plane tangential to the surface of the seabed at the location where the detector is placed.

As illustrated in FIG. 2b, when the seabed is no longer modeled as a horizontal plane, the multiple wave can propagate outside the vertical plane containing the path of the direct wave.

In one embodiment of the invention, for a detector placed on the seabed, one begins by determining the Δ₀ values for each emission point, for example by autocorrelation.

It is possible to determine the parameters D, Bₓ and B_{y} of equation 3 such that Δ₀^{mod} comes closest to the set of Δ₀ values. A person skilled in the art can use any known inversion method for adjusting the parameters D, Bₓ and B_{y} so as to obtain the best possible correspondence with the Δ₀ values determined for each pair of detectors/emission points.

Using the values of the parameters D, Bₓ and B_{y}, it is possible to determine the value of the vertical propagation time by means of the equation:

$${t}_{0} = \frac{D}{\sqrt{8 D - {V}^{2} ( {B}_{x}^{2} + {B}_{y}^{2} )}} . \qquad ( equation 5 )$$

An estimate of the propagation velocity V is sufficient for determining t₀ because, in equation 5, the velocity is second order.

A first evaluation of time t₀ allows calculating Δ₁ without error and using this to estimate the velocity by means of equation 6.

The method can also be used in a loop to reevaluate t₀ if the initial value of V is too far from the subsequently determined value.

The use of equations 5 and 6 provides two independent estimates of the angle γ between the normal to the plane tangential to the surface of the seabed at the location where the detector is placed and the vertical direction, and the angle η between the projection of the normal to the plane tangential to the surface of the seabed at the location where the detector is placed and the X axis in the reference system centered on the detector.

The consistency of the estimates can be used as a quality criterion for the method of the invention.

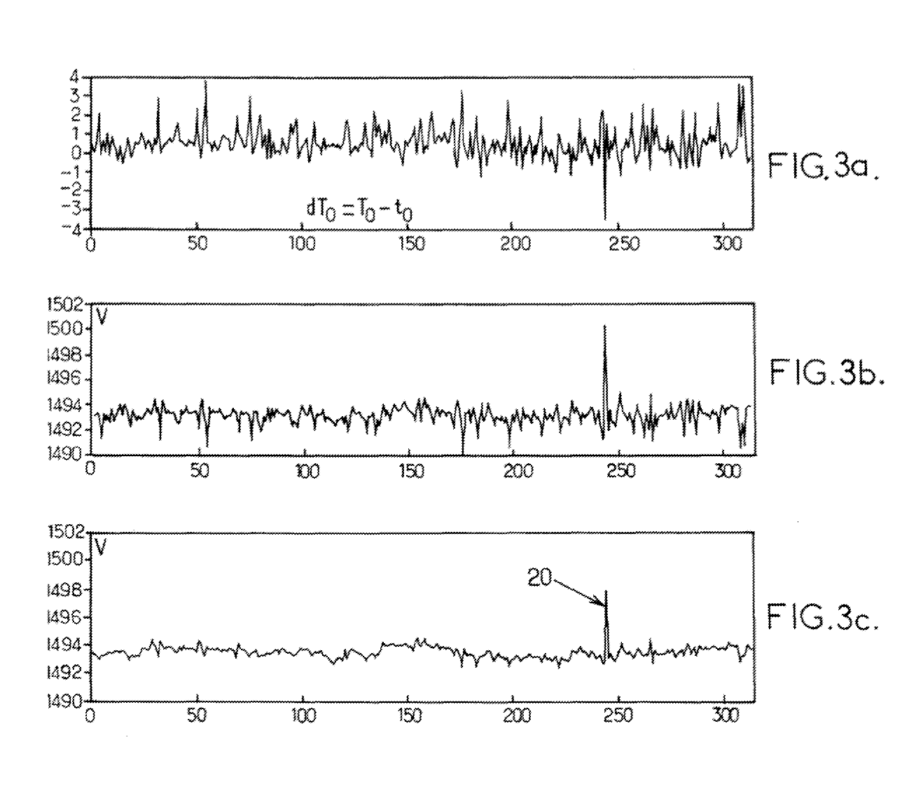

As illustrated in FIG. 3, when multiple detectors are placed on the seabed, the method of the invention allows determining a time shift dT₀ for each detector placed on the seabed.

It is also apparent in FIG. 3 that correction of the mean velocities using the method of the invention improves the consistency of the results and also detects the detectors exhibiting abnormal operation 20.

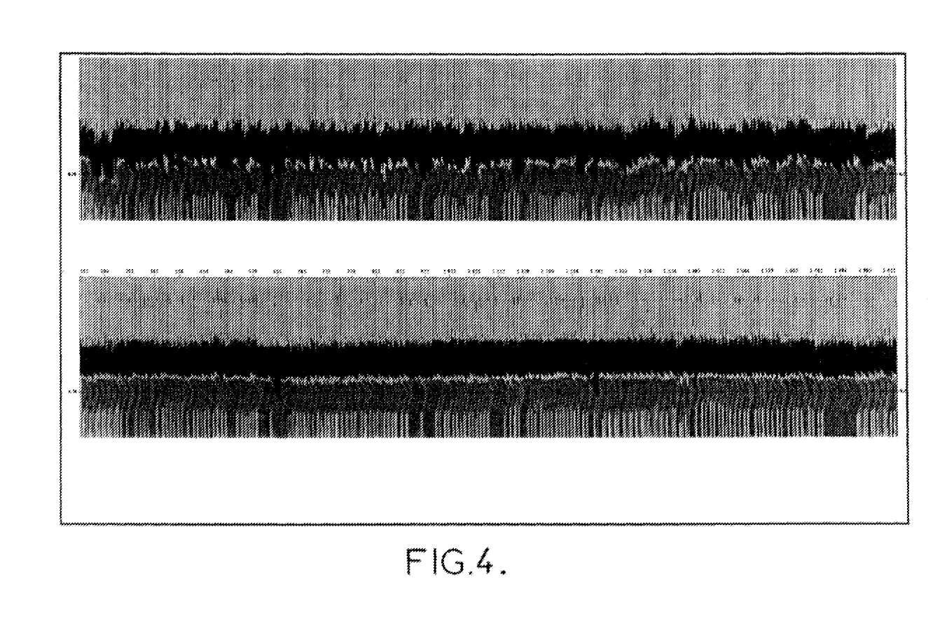

FIG. 4 illustrates the improvement in the consistency of the time origin correction obtained using a method according to the invention.

The recordings are corrected using a move-out correction method

$$t - \frac{\sqrt{{x}^{2 } + {y}^{2} + {z}^{2}}}{V} ,$$

where x, y, z are the coordinates of the point of emission of the wave in a reference system centered on each detector and the time origin is determined by means of the vertical propagation time t₀. The time t₀ and the propagation velocity V are determined by means of a method according to the invention.

The invention is not limited to the embodiments described and is to be interpreted in a non-limiting manner, encompassing any equivalent embodiment.

1-10. (canceled)

11. A method for determining, for a detector placed on the surface of the seabed, a vertical propagation time and a propagation velocity V in the water of at least one wave emitted from at least one emission point among N emission points, said method comprising, for at least one of the N emission points:
emitting at least one wave from said emission point,
recording a wave received by the detector,
determining the vertical propagation time t₀ by means of the following relation: Δ₀=tₘᵤₗ²−t_{dir}²=8t₀², where t_{dir} is the propagation time of the direct wave between the emission point and the detector and tₘᵤₗ is the propagation time of the first multiple wave between the emission point and the detector, and
determining the propagation velocity V of the wave by means of the following relation:
$$\begin{matrix}{Δ}_{1} = 9 {t}_{dir}^{2} - {t}_{mul}^{2} \\ = {( \frac{2 \sqrt{2} X}{V} )}^{2} ,\end{matrix}$$
where X is the distance between the emission point and a point on the water surface that is vertical to the detector.

12. The method of claim 11, wherein the vertical propagation time t₀ is determined by:
resampling the recording of the wave received by the detector according to a change of variable T=t²,
autocorrelating the signal s(T) corresponding to the resampled recording of the wave received by the detector, and
determining the quantity Δ₀ from the value of T corresponding to the main peak of the autocorrelated signal.

13. The method according to claim 11, wherein the propagation velocity is determined by:
resampling the recording of the wave received by the detector according to a change of variable T=9t²,
correlating the signal s(T) corresponding to the resampled recording according to the change of variable T=9t² with the signal s′(T) corresponding to the resampled recording according to a change of variable T=t², and
determining the quantity Δ₁ based on the value of T corresponding to the main peak of the correlated signal.

14. The method of claim 11, wherein the quantity Δ₁ is determined by means of the following relation: Δ₁=8t_{dir}²−Δ₀,
t_{dir} being determined by means of the direct arrival time T_{dir} plotted on the recording of the wave received by the detector, said plotted direct arrival time T_{dir} corrected by the time shift dT₀=T₀−t₀ where T₀ is the estimated vertical propagation time and t₀ is the vertical propagation time determined by means of Δ₀.

15. The method of claim 11, wherein, based on the Δ₀ values determined for each of the N emission points, the Δ₀ values obtained for each of the emission points are modeled by means of the following equation: Δ₀^{mod}=D+Bₓx+B_{y}y, where x and y are the horizontal coordinates for each emission point in a reference system centered on the detector, and where D, B_{X} and B_{y} are modeling parameters for which the values are determined such that Δ₀^{mod} best fits the Δ₀ values obtained,
the vertical propagation time t₀ being determined by means of the following relation:
$${t}_{0} = \frac{D}{\sqrt{8 D - {V}^{2} ( {B}_{x}^{2} + {B}_{y}^{2} )}} .$$

16. The method of claim 11, wherein, based on the Δ₁ values determined for each of the N emission points, the Δ₁ values obtained for each of the emission points are modeled by means of the following equation: Δ₁^{mod}=A(x²+y²)+Fₓx+F_{y}y+E, where x and y are horizontal coordinates for each emission point in a reference system centered on the detector, and where A, F_{X}, F_{Y} and E are modeling parameters for which the values are determined such that Δ₁^{mod} best fits the Δ₁ values obtained,
the propagation velocity V being determined by means of the following relation:
$$V = \frac{2 \sqrt{2}}{\sqrt{A}} .$$

17. The method of claim 15, wherein an angle γ between the normal to the plane tangential to the surface of the seabed at the location where the detector is placed and the vertical direction, and/or an angle η between the projection onto the horizontal plane (X, Y) of the normal to the plane tangential to the surface of the seabed at the location where the detector is placed and the X axis in the reference system centered on the detector, is determined by:
$$η = {tan}^{- 1} ( \frac{{B}_{y}}{{B}_{x}} ) , \\ γ = {tan}^{- 1} ( \frac{V {t}_{0} \sqrt{{B}_{x}^{2} + {B}_{y}^{2}}}{D} )$$

18. The method of claim 16, wherein an angle γ between the normal to the plane tangential to the surface of the seabed at the location where the detector is placed and the vertical direction, and/or an angle η between the projection onto the horizontal plane (X, Y) of the normal to the plane tangential to the surface of the seabed at the location where the detector is placed and the X axis in the reference system centered on the detector, is determined by:
$$η = {tan}^{- 1} ( \frac{{F}_{y}}{{F}_{x}} ) , γ = {sin}^{- 1} ( \frac{\sqrt{{F}_{x}^{2} + {F}_{y}^{2}}}{A V {t}_{0}} ) .$$

19. A method for correcting a time origin of signals recorded by a detector placed on the surface of a seabed, said signals corresponding to waves emitted from at least one emission point among N emission points, wherein the signals received by the detector are corrected by means of a move-out method and by taking into account the time origin with the time t₀ and the propagation velocity V, wherein the time t₀ and the propagation velocity V are determined by a process comprising, for at least one of the N emission points:
emitting at least one wave from said emission point,
recording a wave received by the detector,
determining the vertical propagation time t₀ by means of the following relation: Δ₀=tₘᵤₗ²−t_{dir}²=8t₀², where t_{dir} is the propagation time of the direct wave between the emission point and the detector and tₘᵤₗ is the propagation time of the first multiple wave between the emission point and the detector, and
determining the propagation velocity V of the wave by means of the following relation:
$$\begin{matrix}{Δ}_{1} = 9 {t}_{dir}^{2} - {t}_{mul}^{2} \\ = {( \frac{2 \sqrt{2} X}{V} )}^{2} ,\end{matrix}$$
where X is the distance between the emission point and a point on the water surface that is vertical to the detector.

20. A computer-readable medium having a computer program stored thereon, wherein the computer program comprises a series of instructions which, when loaded onto a computer, causes said computer to execute the steps of a method for determining, for a detector placed on the surface of the seabed, a vertical propagation time and a propagation velocity V in the water of at least one wave emitted from at least one emission point among N emission points, said method comprising, for at least one of the N emission points:
emitting at least one wave from said emission point,
recording a wave received by the detector,
determining the vertical propagation time t₀ by means of the following relation: Δ₀=tₘᵤₗ²−t_{dir}²=8t₀², where t_{dir} is the propagation time of the direct wave between the emission point and the detector and tₘᵤₗ is the propagation time of the first multiple wave between the emission point and the detector,
determining the propagation velocity V of the wave by means of the following relation:
$$\begin{matrix}{Δ}_{1} = 9 {t}_{dir}^{2} - {t}_{mul}^{2} \\ = {( \frac{2 \sqrt{2} X}{V} )}^{2} ,\end{matrix}$$
where X is the distance between the emission point and a point on the water surface that is vertical to the detector.

21. A computer-readable medium having a computer program stored thereon, wherein the computer program comprises a series of instructions which, when loaded onto a computer, causes said computer to execute the steps of a method for correcting a time origin of signals recorded by a detector placed on the surface of a seabed, said signals corresponding to waves emitted from at least one emission point among N emission points, wherein the signals received by the detector are corrected by means of a move-out method and by taking into account the time origin with the time t₀ and the propagation velocity V, wherein the time t₀ and the propagation velocity V are determined by a process comprising, for at least one of the N emission points:
emitting at least one wave from said emission point,
recording a wave received by the detector,
determining the vertical propagation time t₀ by means of the following relation: Δ₀=tₘᵤₗ²−t_{dir}²=8t₀², where t_{dir} is the propagation time of the direct wave between the emission point and the detector and tₘᵤₗ is the propagation time of the first multiple wave between the emission point and the detector,
determining the propagation velocity V of the wave by means of the following relation:
$$\begin{matrix}{Δ}_{1} = 9 {t}_{dir}^{2} - {t}_{mul}^{2} \\ = {( \frac{2 \sqrt{2} X}{V} )}^{2} ,\end{matrix}$$
where X is the distance between the emission point and the point on the water surface that is vertical to the detector.
